(19) United States
(12) Patent Application Publication
(10) Pub. No.: US 2008/0124672 A1
(43) Pub. Date: May 29, 2008

(54) DENTAL IMPLANT DRILL GUIDE WITH HANDLE

(76) Inventor: Harold I. SUSSMAN, Scarsdale, NY (US)

Correspondence Address: NOTARO AND MICHALOS, 100 DUTCH HILL ROAD, SUITE 110, ORANGEBURG, NY, 10962-2100, US

(21) Appl. No.: 11/564,343

(22) Filed: Nov. 29, 2006

(51) Int. Cl. A61C 3/02

(52) U.S. Cl. 433/76

(57) ABSTRACT

A dental implant drill guide for drilling perpendicular holes of different diameters in a jaw bone for receiving an implant has an elongated guide member with a side for engaging the jaw bone, an opposite side, and a third side also for engaging the jaw bone and an opposite and parallel fourth side. A parallel and spaced apart drill guide holes each of a different diameter extend through the guide member between the first and second sides, and parallel and spaced apart drill guide holes each of a different diameter extend through the guide member between the third and fourth sides. A handle is connected to and extends from the guide member and is of a size to be held be the hand of a practitioner for engaging the guide member against the jaw bone. A second version of the drill guide allows for angled application in posterior edentulous sites.

### FIELD AND BACKGROUND OF THE INVENTION

The present invention relates generally to dental implants, and in particular to a new and useful dental implant drill guide which provides a dentist with an intuitive and effective device for properly positioning and drilling the holes needed for various types of dental implants.

Since 1981, dental root form implants have become a standard procedure for replacing missing teeth. Unlike other dental procedures such as crown and bridge work, root canals and the like, which utilize at least part of the original tooth as a foundation for the tooth replacement, implants require the drilling of holes directly into the bone of the jaw.

Although dental implants have many benefits, particularly where a patient is missing teeth over large portions of the mouth, various complications can follow implant placement, especially to adjacent teeth. The bone may be overheated during implant surgery, for example, and this can devitalize an adjacent tooth. Endodontic lesions can also form which compromise the implant fixture by preventing integration of the bone around the fixture (osseointegration), causing loss of the implant.

Another problem involves a patient with no teeth or so called edentulous patients.

A further problem facing the implantologist is the importance of avoiding any invasion of the jaw in the area of the mental foramens or MF, which exist on opposite sides of the lower jaw. No implant hole should be made any closer than 6 mm from either MF or there will be the risk of penetrating an anterior loop of the inferior alveolar nerve which may be present in this area.

Within the confines of the mouth, it is also very difficult to accurately align a dental drill or bur for drilling the crucial initial pilot hole of about 2 mm in diameter needed for a standard implant of about 3 to 4 mm in diameter. The pilot hole must be drilled along an acceptable axis that is perpendicular to the extent of the crest of the jaw bone, into the jaw bone which both avoids any critical structures in the bone such as nerves, blood vessels and the like, but also avoids intersecting the root of an adjacent tooth which may not be apparent without an x-ray. Even with x-rays, however, it is difficult for a dentist to accurately align the bur without some help. The pilot hole is then followed with at least one, but usually multiple larger diameter holes which must each be drilled to gradually enlarge the hole to the final size needed for the implant.

This gradual enlargement of the hole in steps, is necessary since the drilling of one hole to the full diameter needed would cause unacceptable damage and necrosis to the bone. Each hole of the next larger diameter must also be exactly centered and coaxial with the previous hole since, even if the first pilot hole is properly aligned and positions, subsequent holes might be off-center and/or off-axis and therefore introduce the problems that are know to occur in the prior art.

When installing so-called “mini-implants” of only about 1.5 to 2.5 mm diameter, the final hole can be drilled in one step with only an initial pilot starter hole needed, and this hole can be drilled through the gum tissue and into the bone, rather than exposing the jaw bone before drilling takes place as with standard implants. Such mini-implants also have the advantage of being implantable during a single patient visit, unlike standard implants that require a lengthy healing period for allowing the bone of the jaw to incorporate the implant before any dental prostheses can be connected.

Mini-implants are available from IMTEC Corporation of Ardmore, Okla., and are known as the IMTEC Sendax System. U.S. Pat. No. 5,749,732 to Sendax et al. and U.S. Pat. No. 6,716,030 to Bulard et al., further disclose this technology.

U.S. Pat. No. 5,888,065, invented by the present inventor, discloses a dental implant guide arrangement that is capable of accurately guiding a bur for drilling a pilot hole for a standard dental implant. The arrangement includes a pair of jaws which engage lingual and buccal surfaces of a tooth and are held to each other by a fixing mechanism, such as a screw. A guide member extends from one of the jaws and has a semi-cylindrical guide that is parallel to an acceptable axis for the pilot hole. The bur can be guided along the guide for accurately drilling the pilot hole. Also see the inventors U.S. Pat. Nos. 6,062,856; 6,626,667 and 6,869,283; and his published U.S. patent application US 2005/0282106.

A complex and time consuming technique for properly aligning the initial implant hole is disclosed in U.S. Pat. No. 5,015,183. According to this method, a stent comprising a negative impression of a patient's teeth in the vicinity of the implant is taken. Multiple x-ray opaque strips are placed in the negative impression and an oblique x-ray is taken. This x-ray is used as a diagnostic tool for the patient's jaw structure to help plot the trajectory of an implant fixture in the jaw. Another problem associated with the use of a stent is that when a surgical stent is fabricated from an alginate jaw impression, as is commonly done, the registration of the surface jaw tissue does not always reflect the underlying topography of the jaw bone where the implant is to be placed.

In any case, once an acceptable initial implant hole is formed in the jaw, subsequent holes can be produced by using the initial hole as a guide. This is when multiple implants are to be installed. See, for example, U.S. Pat. Nos. 5,741,133 and 5,302,122. Other techniques and apparatuses for drilling holes in the jaw bone are disclosed in U.S. Pat. Nos. 4,787,848 and 4,998,881.

U.S. Pat. No. 5,842,859 discloses a simple implant hole drilling guide but with only an open guide surface but no encircling guide bore for the drill. U.S. Pat. No. 5,833,693 uses a circular but not cylindrical drill guide bore and a length adjustable block with a downwardly extending hole engaging pin and an upwardly extending handle. Also see U.S. Pat. No. 4,325,373 for a guide with a hole engaging pin.

Also see U.S. Pat. Nos. 5,320,529 and 5,954,769, and published U.S. patent applications US 2002/0137003 and US2003/0008262.

### SUMMARY OF THE INVENTION

The present invention is used to properly locate and drill the critical first holes for standard or mini-implants, perpendicular to the jawbone crest, and the subsequent larger diameter holes which are all properly co-axial with the first hole. This can be done for the upper or the lower jaw of a patient, and whether the patient has no teeth (edentulous) or some teeth.

Accordingly, an object of the present invention is to provide an implant drill guide for use in drilling multiple concentric and co-axial holes in a jaw bone in preparation for receiving a dental implant, the jaw bone having a ridge for receiving an entry opening of each hole to be drilled.

Another object of the invention is to provide such a guide which comprises a preferably elongated guide member having a first side for engaging the ridge of the jaw bone when the guide member is engaged onto the jaw bone, and an opposite, parallel second side; a plurality of parallel, spaced apart drill guide holes each of a different diameter and each extending through the guide member between the first and second sides, the drill guide holes being spaced in line along the guide member; and a preferably elongated handle connected to and extending from the guide member, the handle being of a size to be held be the hand of a practitioner for engaging the guide member against the jaw bone.

The guide according to the invention has a handle of about 5 to 15 cm long, a guide member of about 2 to 10 cm long, and each drill guide hole having a different diameter within the range of about 1.5 to 6 mm. By providing a handle that can be grasped by most or all of the hand, the practitioner has a firm positive hold on the guide member and can accurately place it over the desired location on the jaw bone ridge, either directly, if the gum has been moved aside, or on the gum.

Various handle structures and safety features can be used in the guide of the invention and the size and placement of the bores will vary depending on whether the guide is used for standard or mini-implants.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top view of an implant drill guide illustrating a first embodiment of my invention for drilling the hole needed for standard 3.75 mm self-tapping fixtures or implants;

FIG. 2 is a side view of the embodiment of FIG. 1;

FIG. 3 is a front or front end view of the embodiment of FIG. 1;

FIG. 4 is a top view of an implant drill guide illustrating a second embodiment of my invention for drilling holes for additional mini-implants or for drilling holes for standard implants;

FIG. 5 is a side view of the embodiment of FIG. 4;

FIG. 6 is a front or front end view of the embodiment of FIG. 4; and

FIG. 7 is a top view of a third, adjustable embodiment of my invention for drilling holes for dental implants in a variety of positions.

### DESCRIPTION OF THE PREFERRED EMBODIMENTS

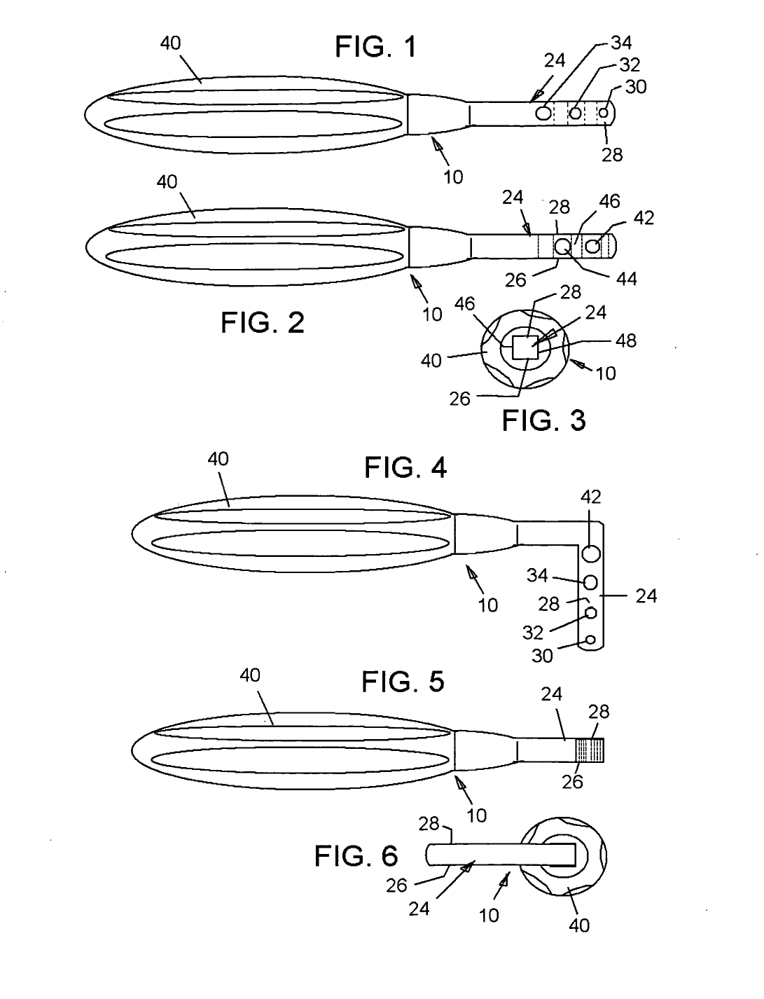

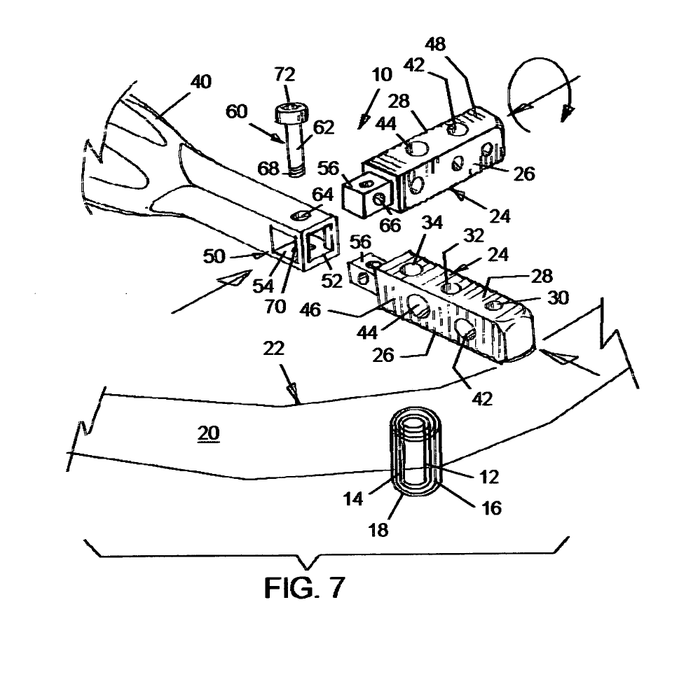

Referring now to the drawings in which like reference numerals are used to refer to the same or functionally similar elements, FIGS. 1, 4 and 7 illustrate three embodiments of an implant hole guide 10 for use in drilling plural holes of different diameters 12, 14, 16 and 18 (see FIG. 7), in a jaw bone 22 in preparation for receiving a dental implant, the jaw bone having a ridge 20 for receiving an entry opening of a hole to be drilled.

The guide of the invention comprises an elongated guide member 24 having a first side 26 for engaging the ridge 20 of the jaw bone 22 when the guide member is engaged onto the jaw bone, and an opposite, parallel second side 28. The sides have parallel ridges or a rough surface to form anti-slip means when engaged to the jaw bone ridge.

A plurality of parallel, spaced apart drill guide holes 30, 32 and 34, each of a different diameter, e.g. 2.1 mm±0.2 mm, 2.9 mm±0.2 mm and 3.5 mm±0.2 mm respectively, extend through the guide member 24 between the first and second sides 26, 28. The drill guide holes are spaced in line along the guide member 24 and an elongated handle 40 is connected to one end of the guide member. The handle is of a size to be held by the hand of a practitioner for engaging the guide member against the jaw bone, for example about 11 cm long or preferably in the range of about 5 to 15 cm long and about 1 to 3 cm in diameter, although the cross-sectional shape can be any appropriate handle shape that is known to be effectively held by the hand of a practitioner.

The holes 30, 32 and 34, as well as additional holes for guiding larger diameter drills to be described later in this disclosure, are all preferably in the range of about 1.5 mm to about 6 mm in diameter, for accommodating and therefore guiding all known, and most likely to be discovered implant hole requirements.

The guide member 24 extends either parallel to, and therefore is in line with the elongated handle 40 as in FIG. 1, or is at a non-zero angle, preferably but not necessarily 90 degrees, to the handle 40 as in the embodiment of FIG. 4. The embodiment of FIG. 7 utilizes an adjustable connection between the guide member 24 and the handle 40 so that various positions for accessing various edentulous jaw ridge surfaces can be achieved.

FIGS. 2 and 3 show a third side 46 and an opposite and parallel fourth side 48 which also have a plurality of drill guide holes 42 and 44 extending therebetween for guiding large diameter drills. For this purpose hole 42 is for example about 4.1 mm±0.2 mm in diameter and hole 44 is about 4.7 mm±0.2 mm in diameter.

To use the guide of the present invention, the practitioner holds the handle 40 and engages the first side 26 of the guide member 24 against the ridge 20 of the jaw bone 22 with the smallest diameter guide hole 30 over the desired location for the pilot hole of the first implant to be installed. The practitioner then uses his or her other hand to drill the pilot hole using a conventional handpiece and drill of the correct size. The diameter of each guide hole is selected be only slightly greater than that of the drill to be used, e.g. 0.2 to 0.5 mm greater. If the guide member 24 is make of metal, e.g. titanium or stainless steel, each guide hole 30, 32, 34, 42 and 44 is simply formed in the guide member between opposite surfaces thereof. If the guide member is made of hard plastic, e.g. a carbonate, a metal sleeve is provided to line each hole, for example, a titanium cylindrical sleeve having the desired inside diameter is provided for each guide hole. The purpose is to resist cutting of the guide holes by the drill as the hole is being made in the jaw bone.

After the pilot hole is drilled, the practitioner than moves the guide member so that the next larger guide hole 32 is over the pilot hole that has just been drilled. The next larger sized drill is then used to enlarge the pilot hole one step larger. Since the handle is of ample size and the placement of the guide member using the handle is clear and positive, there is little danger that the enlargement hole will go off-axis or off-center.

This process is repeated for each enlargement until the final desired hole size has been reached. For the embodiments of FIG. 1 and 7, this includes rotating or re-positioning the guide member 24 so that the third side 46 is engaged with the ridge 20 for use of the larger diameter guide hole set 42 and 44. For the embodiment of FIG. 4, the guide holes of increasing size are spaced in one line along the guide member. In FIGS. 4, 5 and 6, the guide member is shown to be at a non-zero angle, e.g. 90 degrees, to the axis of the handle 40. In practice, the practitioner may use both the guide of FIG. 1 and that of FIG. 4 since the angled embodiment (FIGS. 4, 5 and 6) may be better for accessing certain posterior areas of the patients mouth where teeth are missing, while the straight embodiment (FIGS. 1, 2 and 3) may be better for other areas.

As will be explained later in greater detail, the embodiment of FIG. 7 uses a detachable guide member 24 that can be engaged to the handle in different positions, at least one of which is straight and at least one of which is angled.

Although in the preferred angled embodiment, the angle is 90 degrees, other angles may also be used, e.g. 30, 45 or 60 degrees.

More or fewer guide holes of stepped, increasing sizes can be provided, depending on the diameter of the final implant hole needed in the jaw bone, and on the number of incremental diameter increases needed to enlarge the implant hole without overly damaging the bone. Although the cross section of the guide member 24 is shown to be square in FIGS. 3 and 5 for example, other polygonal shapes can be used, for example a hexagonal cross-sectioned guide member of the present invention may have three pairs of opposite, parallel sides with guide holes of differing diameter between them to accommodate a greater number of spaced guide holes. It is also noted that the guide holes may intersect each other inside the body of the guide member without adversely affecting the usefulness of the invention since, as long as the entry and exit ends of the guide holes are intact, the guiding function of the guide holes is achieved.

In the embodiment of FIG. 7, the guide member 24 is detachably connected to the handle 40 by a multi-directional socket 50 at the end of the handle. The socket may instead be on the end of the guide member with tenons to be explained, being on the end of the handle. The socket 50 is made up of one mortise or square or at least non-round hole 52 in the end of handle 40, and at least one, but alternatively two opposite mortises 54 on opposite sides of the mortise 52. In the embodiment illustrated, the guide member 24 has a tenon or square or at least non-round projection 56 that is shaped to be closely received in one of the mortises 52 or 54 for connecting the guide member to the handle so that the guide member and handle are either parallel to each other when tenon 56 is in mortise 52, or, when tenon 56 is in one of the mortises 54, and so that the guide member and handle are at a non-zero angle, e.g. 90 degrees, to each other. By using a square mortise and tenon combination for the socket 50, the guide member 24 can also be rotated in the direction of the curved arrow in FIG. 7 by 90 degrees, so that either the small hole set 30, 32, 34 is Up, or the larger hole set 42, 44 is up. By including two side mortises 54 and the end mortise 52, straight, right-handed and left-handed position can all be achieved for all hole sets, e.g. six separate positions are possible for the guide member on the handle. To positively retain the guide member 24 to the handle 40, the invention can also include fixing means in the form of a screw 60 with a smooth shaft 62 that can extend through a hole 64 in the top of the handle end over the mortises, and an aligned hole 66 in the tenon, and have a threaded end 68 that can screw into a threaded hole 70 in the handle end below the mortises. A head 72 of screw 60 is knurled and/or has a hex or other shaped hole for a suitable driver to engage the screw to the holes and fix the guide member in its selected place. Hole 66 in tenon 56 is actually a pair of crossing holes so that the screw 60 can be used to hold the guide member to the handle with either hole set in the up position.

While specific embodiments of the invention have been shown and described in detail to illustrate the application of the principles of the invention, it will be understood that the invention may be embodied otherwise without departing from such principles.

What is claimed is:

1. A dental implant drill guide for use in drilling plural holes of different diameters in a jaw bone in preparation for receiving a dental implant, the jaw bone having a ridge for receiving an entry opening of a hole to be drilled, the guide comprising:
a guide member having a polygonal cross-section with a first side for engaging the ridge of the jaw bone when the guide member is engaged onto the jaw bone, and an opposite, parallel second side, and a third side also for engaging the ridge of the jaw bone when the guide member is engaged onto the jaw bone, and an opposite, parallel fourth side, the first and third sides being at a selected angle to each other around the polygonal cross-section;
a first plurality of parallel, spaced apart drill guide holes each of a different diameter and each extending through the guide member between the first and second sides, and a second plurality of parallel and spaced apart drill guide holes each of a different diameter and each extending through the guide member between the third and fourth sides, the first and second plurality of drill guide holes being at the selected angle from each other; and
a handle connected to and extending from the guide member, the handle being of a size to be held be the hand of a practitioner for engaging the guide member against the jaw bone.

2. A guide according to claim 1, wherein each of the first and second plurality of holes are spaced along a length of the guide member from one end of the guide member connected to the handle, to an opposite free end of the guide member.

3. A guide according to claim 1, wherein the guide member has four sides and the selected angle is 90 degrees.

4. A guide according to claim 1, including anti-slip means on the first, second, third and fourth sides of the guide member to prevent slipping of the guide member on the jaw bone by either engaging gum tissue over the jaw bone ridge if the guide member is to be used for drilling holes into the jaw bone through the gum tissue, or by directly engaging the ridge after the gum tissue has been moved aside if the guide member is to be used for drilling a holes directly into exposed jaw bone.

5. A guide according to claim 1, including spaced parallel ridges on the first, second, third and fourth sides of the guide member to prevent slipping of the guide member on the jaw bone by either engaging gum tissue over the jaw bone ridge if the guide member is to be used for drilling holes into the jaw bone through the gum tissue, or by directly engaging the ridge after the gum tissue has been moved aside if the guide member is to be used for drilling a holes directly into exposed jaw bone.

6. A guide according to claim 1, wherein the guide member and the handle are both elongated and are parallel to each other.

7. A guide according to claim 1, wherein the guide member and the handle are both elongated and are at a non-zero angle to each other.

8. A guide according to claim 1, wherein the guide member and the handle are both elongated and are at 90 degrees to each other.

9. A guide according to claim 1, wherein the guide member and handle is made of plastic and include a metal lining in each of the holes.

10. A guide according to claim 1, wherein the guide member and the handle are made of sterilizeable metal.

11. A guide according to claim 1, wherein the guide member is detachably connected to the handle.

12. A guide according to claim 1, wherein the guide member is detachably connected to the handle by a multi-directional socket in one of the handle and the guide member, that connects the guide member to the handle so that the guide member and handle are parallel to each other and so that the guide member and handle are at a non-zero angle to each other.

13. A guide according to claim 1, wherein the guide member is detachably connected to the handle by a multi-directional socket in one of the handle and the guide member, that connects the guide member to the handle so that the guide member and handle are parallel to each other and so that the guide member and handle are at 90 degrees to each other, the guide member having four sides and the selected angle being 90 degrees, the socket being shaped to connect the guide member with either the first side up of the third side up.

14. A guide according to claim 1, wherein the guide member is made of transparent plastic and including a metal lining in at least one of the first and second bores.

15. A guide according to claim 1, wherein the handle is elongated and is about 5 to 15 cm long and the guide member is elongated and is about 2 to 10 cm long, each drill guide hole having a different diameter within the range of about 1.5 to 6 mm.

16. A guide according to claim 1, wherein the guide member is detachably connected to the handle by a multi-directional socket in one of the handle and the guide member, that connects the guide member to the handle so that the guide member and handle are parallel to each other and so that the guide member and handle are at 90 degrees to each other, the guide member having four sides and the selected angle being 90 degrees, the socket being shaped to connect the guide member with either the first side up of the third side up, and including guide member fixing means for fixing the guide member at one position to the handle.

17. A dental implant drill guide for use in drilling plural holes of different diameters in a jaw bone in preparation for receiving a dental implant, the jaw bone having a ridge for receiving an entry opening of a hole to be drilled, the guide comprising:
an elongated guide member having a first side for engaging the ridge of the jaw bone when the guide member is engaged onto the jaw bone, and an opposite, parallel second side;
a plurality of parallel, spaced apart drill guide holes each of a different diameter and each extending through the guide member between the first and second sides, the drill guide holes being spaced in line along the guide member; and
an elongated handle connected to and extending from the guide member, the handle being of a size to be held be the hand of a practitioner for engaging the guide member against the jaw bone.

18. A guide according to claim 17, wherein guide member extends at a non-zero angle from the end of the handle.

19. A guide according to claim 17, wherein the handle is about 5 to 15 cm long and the guide member is about 2 to 10 cm long, each drill guide hole having a different diameter within the range of about 1.5 to 6 mm.

20. A dental implant drill guide for use in drilling plural holes of different diameters in a jaw bone in preparation for receiving a dental implant, the jaw bone having a ridge for receiving an entry opening of a hole to be drilled, the guide comprising:
an elongated guide member having a first side for engaging the ridge of the jaw bone when the guide member is engaged onto the jaw bone, and an opposite, parallel second side;
a plurality of parallel, spaced apart drill guide holes each of a different diameter and each extending through the guide member between the first and second sides, the drill guide holes being spaced in line along the guide member; and
an elongated handle connected to and extending at about 90 degrees from the guide member, the handle being of a size to be held be the hand of a practitioner for engaging the guide member against the jaw bone;
the handle being about 5 to 15 cm long and the guide member being about 2 to 10 cm long, and each drill guide hole having a different diameter within the range of about 1.5 to 6 mm.

21. A dental implant drill guide for use in drilling plural holes of different diameters in a jaw bone in preparation for receiving a dental implant, the jaw bone having a ridge for receiving an entry opening of a hole to be drilled, the guide comprising:
a guide member having a polygonal cross-section with a first side for engaging the ridge of the jaw bone when the guide member is engaged onto the jaw bone, and an opposite, parallel second side, and a third side also for engaging the ridge of the jaw bone when the guide member is engaged onto the jaw bone, and an opposite, parallel fourth side, the first and third sides being at a selected angle to each other around the polygonal cross-section;
at least one first drill guide hole of one diameter extending through the guide member between the first and second sides, and at least one second drill guide hole of a different diameter extending through the guide member between the third and fourth sides, the first and second drill guide holes being at the selected angle from each other; and
a handle connected to and extending from the guide member, the handle being of a size to be held be the hand of a practitioner for engaging the guide member against the jaw bone.
